(19) United States
(12) Patent Application Publication
(10) Pub. No.: US 2025/0081098 A1
(43) Pub. Date: Mar. 6, 2025

(54) Enhanced Link Loss Detection and Parent Reselection for Power Constrained Accessories

(71) Applicant: Apple Inc., CUPERTINO, CA (US)

(72) Inventors: Sarvesh Kumar VARATHARAJAN, Milpitas, CA (US); Riteshkumar S PATEL, CUPERTINO, CA (US); Venkateswara Rao MANEPALLI, San Jose, CA (US)

(21) Appl. No.: 18/817,643

(22) Filed: Aug. 28, 2024

Related U.S. Application Data
(60) Provisional application No. 63/579,829, filed on Aug. 31, 2023.

(51) Int. Cl. H04W 52/02; H04W 84/18

(52) U.S. Cl. CPC H04W 52/0212; H04W 84/18

(57) ABSTRACT

An apparatus configured to process, based on signaling received from a child device, a data request, determine whether an active context exists with the child device based on data stored in firmware and determine whether to respond to the data request based on whether the active context exists with the child device.

### PRIORITY/INCORPORATION BY REFERENCE

This application claims priority to U.S. Provisional Application Ser. No. 63/579,829 filed on Aug. 31, 2023 entitled “Enhanced Link Loss Detection and Parent Reselection for Power Constrained Accessories,” the entirety of which is incorporated by reference herein.

### BACKGROUND

Parent devices may interact with sleepy end devices (SEDs) (e.g., child devices), which encompass a variety of connected smart home devices such as locks, thermostats, and sensors. The Institute of Electrical and Electronics Engineers (IEEE) 802.15.4 standard defines the technical specifications for low-rate, low-power wireless personal area networks (WPANs). Emerging protocols use the 802.15.4 standard for smart home use cases.

SEDs are typically battery powered and are highly power constrained. Minimization of SED power use is an ongoing concern in the field. SEDs send periodic Medium Access Control Data Request frames to a powered device, which acts as a parent to the SED. During initial attach procedures, a SED selects a parent. All communication to and from the SED is then routed through the parent. Maintenance of the parent-child link is critical for reliable communication and battery use of the SED. Enhanced parent-child link maintenance procedures are needed in the field to address the existing limitations of parent-child link maintenance including link loss detection and recovery time, power consumption, compatibility, overhead and reliability.

### SUMMARY

Some example embodiments are related to an apparatus having processing circuitry configured to process, based on signaling received from a child device, a data request, determine whether an active context exists with the child device based on data stored in firmware and determine whether to respond to the data request based on whether the active context exists with the child device.

Some example embodiments are related to a wireless communication device having transceiver circuitry configured to communicate with a child device and processing circuitry communicatively coupled to the transceiver circuitry and configured to process, based on signaling received from the child device, a data request, determine whether an active context exists between the wireless communication device and the child device based on data stored in firmware and determine whether to respond to the data request based on whether the active context exists with the child device.

Some example embodiments are related to a method performed by a parent device, the method including processing, based on signaling received from a child device, a data request, determining whether the parent device has an active context with the child device based on data stored in firmware of the parent device and determining whether to respond to the data request based on whether the parent device has the active context with the child device.

### BRIEF DESCRIPTION OF THE DRAWINGS

FIG. 1 shows an example network arrangement according to various example embodiments.

FIG. 2 shows an example parent device according to various example embodiments.

FIG. 3 shows a parent-child arrangement according to various example embodiments.

FIG. 4 shows a call flow between a parent device and a SED according to various example embodiments.

FIG. 5 shows a method for operations performed by a parent device in a parent-child relationship with a SED device according to various example embodiments.

### DETAILED DESCRIPTION

The example embodiments may be further understood with reference to the following description and the related appended drawings, wherein like elements are provided with the same reference numerals. The example embodiments relate to improved parent behavior for SED link degradation scenarios.

The example embodiments are described with regard to a parent device. However, reference to a parent device is merely provided for illustrative purposes. The example embodiments may be utilized with any electronic component that may establish a connection to a network and is configured with the hardware, software, and/or firmware to exchange information and data with the network. Therefore, the parent device as described herein is used to represent any electronic component.

Operations and logic are disclosed herein for enhancements to parent-child link loss detection and parent reselection. Smart home devices have grown in popularity in recent years and are expected to continue to grow in use rapidly. Standards such as Thread, Matter, and Zigbee have increased the interoperability between various parent devices and SEDs (e.g., child devices).

A SED selects a parent device during initial attach procedures. All communications to and from the SED is routed through the parent device. As discussed above, optimal maintenance of the parent-child link is crucial for reliable communications with the SED and reduced battery use of the SED.

There may be scenarios in which the parent device and child device have not entirely lost communication between one another, but signal interference leads to packet loss and a low quality connection. Unlike a total signal loss, which would trigger a parent reselection procedure by the child device, poor parent-child connections may persist and waste both signaling time and limited child battery capacity.

Several existing parent-child link maintenance procedures have been implemented; however, each has various limitations that reduce their effectiveness. The Thread 1.1 standard defines that a child update request message is sent periodically by the child. This child update message has a large signaling overhead. Additionally, link failure detection and link failure recovery operations occur on the order of minutes.

The Thread 1.2 standard defined an enhanced keep alive mechanism using acknowledgement messages (ACKs) for periodic data requests. A parent device using Thread 1.2 may remove a child context but may still send an ACK in response to a data request message sent by the child. This implementation has negative implications for signaling reliability and child battery performance. The Thread 1.3.1 standard defined a child supervision procedure, in which the parent device must periodically send an empty frame to the child to maintain the inactive link. Both the parent device and child device must be Thread 1.3.1 compatible, which may not always be the case when the parent device and child device are from different original equipment manufacturers (OEMs). Further, this implementation has an overhead to exchange the additional empty frame and synchronize supervision related parameters.

The example embodiments provide manners of managing a parent-child relationship such that when a parent device removes a child context, the child device is informed in a timely manner that the parent-child relationship no longer exists. The child device is informed when the parent device no longer acknowledges data requests sent by the child device when performing link maintenance procedures.

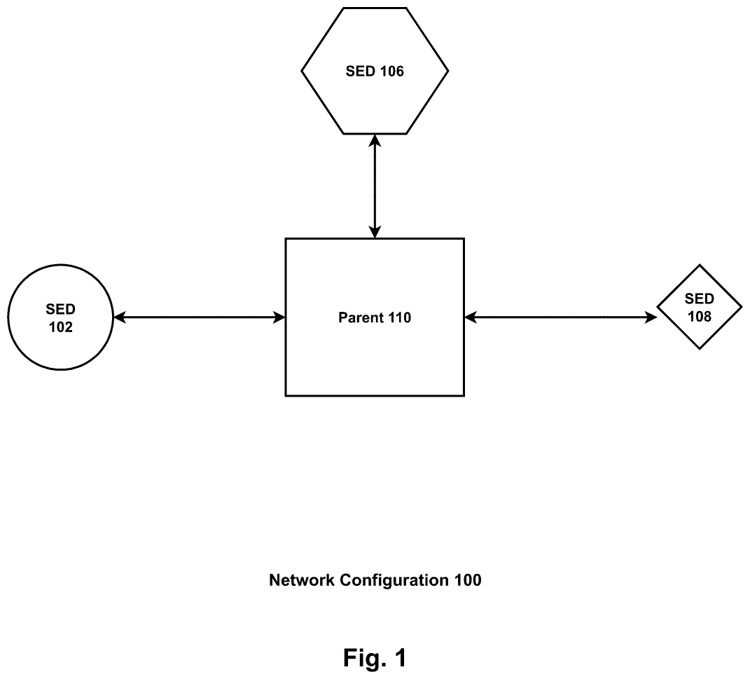

FIG. 1 shows an example network arrangement 100 according to various example embodiments. The example network arrangement 100 includes a parent device 110. The parent 110 may be any type of electronic component that is configured to communicate via a network, e.g., home hubs, mobile phones, tablet computers, desktop computers, smartphones, embedded devices, wearables, Internet of Things (IoT) devices, etc. An actual network arrangement may include any number of parent devices. Thus, the example of one parent device 110 is merely provided for illustrative purposes. The parent device 110 may serve as a parent to a child device, such as a sleepy end device (SED). The network configuration 100 includes a SED 102, a SED 106, and a SED 108. The SEDs 102-108 each may be a child device to the parent device 110. Each of the SEDs 102-108 may be a same type of SED, or different types of SEDs. For example, the SED 102 may be a smart lock, the SED 106 may be a door sensor and the SED 108 may be a smart thermostat. In other variants, the SEDs 102-108 may have substantially the same functionality as the parent device 110. In still further variants, the SEDs 102-108 may have a reduced feature set compared to the parent device 110. Thus, the parent device may include any wireless communication device.

Typically, the parent device 110 may have a larger battery capacity or may have access to line power (e.g., may be plugged in) compared to the SEDs 102-108 that may be battery constrained devices. However, this relative battery capacity is not a requirement of the example embodiments.

The parent device 110 may be configured to communicate with one or more networks, e.g., a Wi-Fi network, a cellular network, etc. As described above, all communications of the SEDs 102-108 may be routed through the parent device 110. Thus, the parent device 110 and each of the SEDs 102-108 may communicate via a wireless short range communication protocol.

To provide one non-limiting example, the parent device 110 may be a smart home hub such as a smart speaker that is connected to a home Wi-Fi network that allows communication access to the parent device 110. The SED 108 may be a thermostat in the home. An owner of the home (e.g., user) may be at a remote location and may wish to access the thermostat 108 to change the temperature in the home before the owner returns home. The user may communicate with the thermostat 108 via an application on the user's mobile phone. The communication may be routed through the public Internet to the home Wi-Fi network to the smart home hub 110, which may then send the communication via the short range protocol connection to the thermostat 108.

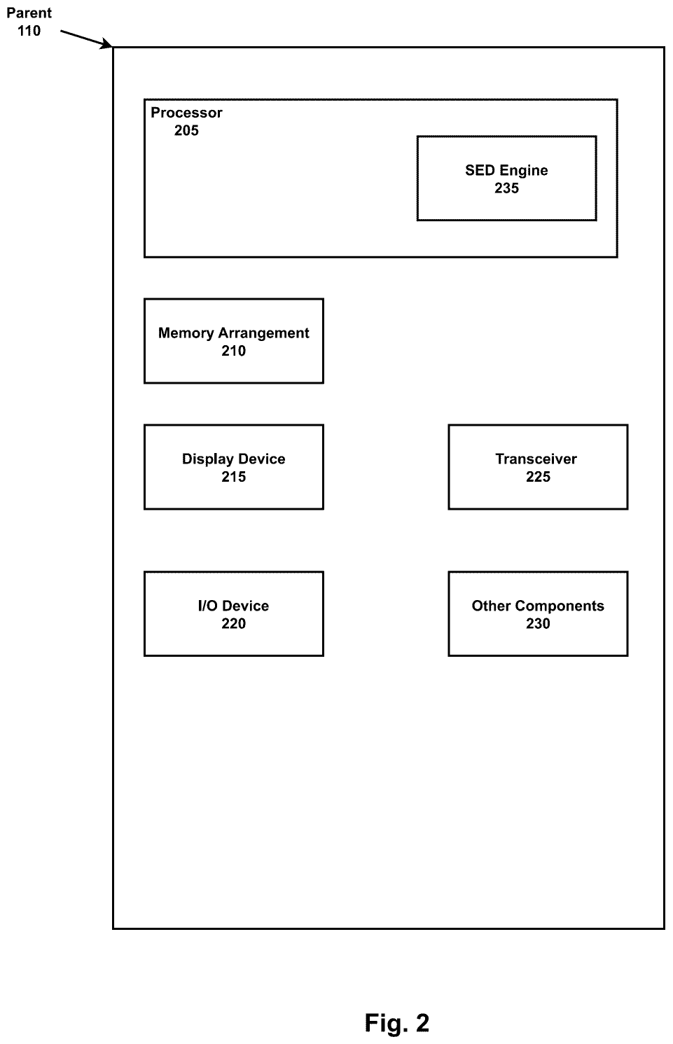

FIG. 2 shows an example parent device 110 according to various example embodiments. The parent device 110 will be described with regard to the network arrangement 100 of FIG. 1. The parent device 110 may represent any electronic device and may include a processor 205, a memory arrangement 210, a display device 215, an input/output (I/O) device 220, a transceiver 225, and other components 230. The other components 230 may include, for example, an audio input device, an audio output device, a data acquisition device, ports to electrically connect the parent device 110 to other electronic devices, sensors to detect conditions of the parent device 110, etc.

The processor 205 may be configured to execute a plurality of engines for the parent device 110. For example, the engines may include a SED engine 235 for performing operations related to managing a connection between the parent device 110 and child SED devices including, but not limited to, updating child tables, moving child tables to firmware, and determining whether to send an ACK to a child based on the child table. Examples of these operations will be described in greater detail below.

The above referenced engine being an application (e.g., a program) executed by the processor 205 is only an example. The functionality associated with the engines may also be represented as a separate incorporated component of the parent device 110 or may be a modular component coupled to the parent device 110, e.g., an integrated circuit with or without firmware. For example, the integrated circuit may include input circuitry to receive signals and processing circuitry to process the signals and other information. The engines may also be embodied as one application or separate applications. In addition, in some parent devices, the functionality described for the processor 205 is split among two or more processors such as a baseband processor and an applications processor. The example embodiments may be implemented in any of these or other configurations of a parent device.

The memory arrangement 210 may be a hardware component configured to store data related to operations performed by the parent 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with one or more networks such as a Wi-Fi network or a cellular network. The transceiver 225 may be configured with a network interface card that allows a wired connection to the one or more networks (e.g., Ethernet connection) or may communicate wirelessly with the one or more networks. As described above, the parent device 110 may also communicate via a wireless short range connection with SED devices. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

The example embodiments disclose operations and logic for enhanced link loss detection. A parent device (e.g., the parent device 110) may remove a context of a child device (e.g., any of SED 102-108). This may occur for a variety of reasons, such as link degradation. Removing the SED context is not equivalent to deleting or blocking communications with the SED. Existing implementations allow for the parent device to continue responding to data requests from the SED, despite the SED context being removed. The reasoning for this unwanted behavior is related to the speed at which the parent device must respond to the data request sent by the SED. IEEE standards call for the parent device to respond to an IEEE 802.15.4 data request on the order of 192 μs (microseconds). This short length of time is insufficient for the parent device to check if the data request is coming from a child that has had its context removed. With insufficient time to check the child context, the parent device responds with an ACK to the child, despite having removed the child context due to link degradation. These ACKs waste signaling and battery for both the parent device and child device. Additionally, continuing to receive ACKs prevents the child from initiating parent reselection procedures.

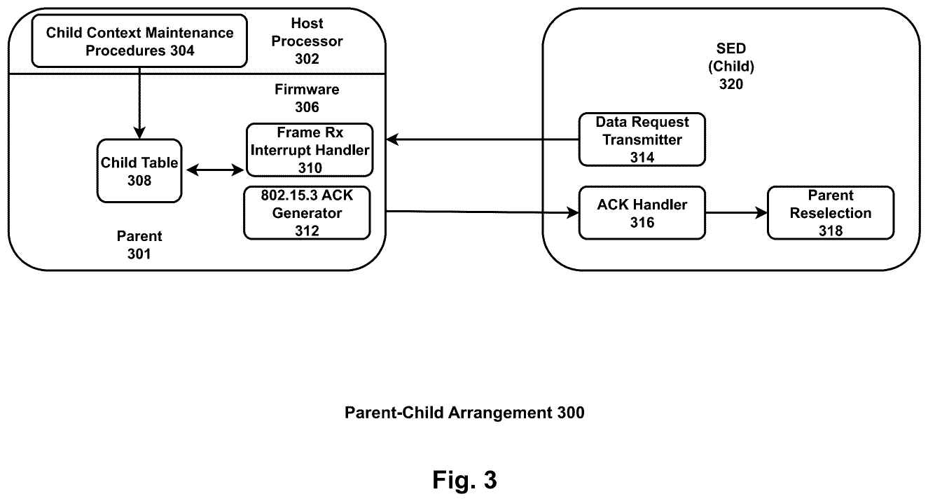

FIG. 3 shows a parent-child arrangement 300 according to various example embodiments. The arrangement 300 includes a parent device 301 that may include features and functionality substantially similar to the parent device 110 and a SED 320. The parent device 301 includes a host processor 302 and firmware 306. As described above, because the parent device 301 is required by standard to respond quickly to a data request from the SED 320, the handling of the data request is performed in the firmware 306, e.g., requiring the data request to be processed by the host processor 302 may result in the parent device 301 not responding in the standard specified time of 192 μs.

During normal operation, the SED 320, using a data request transmitter 314 will transmit a data request to the parent device 301. A frame reception (Rx) interrupt handler 310 implemented in the firmware 306 of the parent device 301 receives the data request. The frame Rx interrupt handler 310 may execute an interrupt service routine (ISR) to handle received frames. An 802.15.3 ACK generator 312 implemented in the firmware 306 of the parent device 301 may then generate an ACK and transmit the ACK in response to the SED 320.

As described above, there may be instances where a parameter of a communication link between the parent device 301 and the SED 320 is below a predefined threshold, causing the parent device 301 to remove the context of the SED 320, e.g., the parent device 301 is no longer the parent of the SED 320. Such instances can include a link quality of a communication link between the parent device 301 and the SED 320 degrading, e.g., below a predefined threshold. Link quality may be measured in parameters including, for example, Received Signal Strength Indication (RSSI), Signal-to-Interference-plus-Noise Ratio (SINR), Packet-Delivery Ratio (PDR), Bit-Error Rate (BER), etc. As also described above, because the parent device 301 is required by standard to respond to the data request in a short amount of time (e.g., 192 μs), the firmware 306 cannot send the data request to the host processor 302 to check the context of the SED 320 (e.g., was the context of the SED 320 removed). Thus, the parent device 301 will respond to the data request even though the context of the SED 320 has been removed.

The example embodiments address this issue by the host processor 302 maintaining a child table 308 in the firmware 306, which may allow the firmware 306 to check if the context of the child (e.g., SED 320) has been removed.

The host processor 302 of the parent device 301 may, for example, execute the SED engine 235 described above. Executing the SED engine 235 may cause the host processor 302 to implement child context maintenance procedures 304. These child context maintenance procedures 304 may include adding a context for a child, removing a context for a child, etc. The child context maintenance procedures 304 may also include maintaining a child table 308 in the firmware 306 of the parent device 301. The child table 308 may contain information on all contexts corresponding to active (e.g., linked) child devices. In the example of FIG. 3, if the SED 320 is an active child of the parent device 301, the child table 308 may include an entry for the SED 320. However, if the host processor 302 removes the context for the SED 320, the entry will be removed from the child table 308.

Because the child table 308 is maintained in the firmware 306, the parent device 301 may access the child table 308 when responding to the data request from the SED 320. For example, if the parent device 301 receives a data request from the SED 320, prior to generating and transmitting an ACK for the data request, the firmware 306 may check the child table 308 to determine if the parent device has an active context with the SED 320.

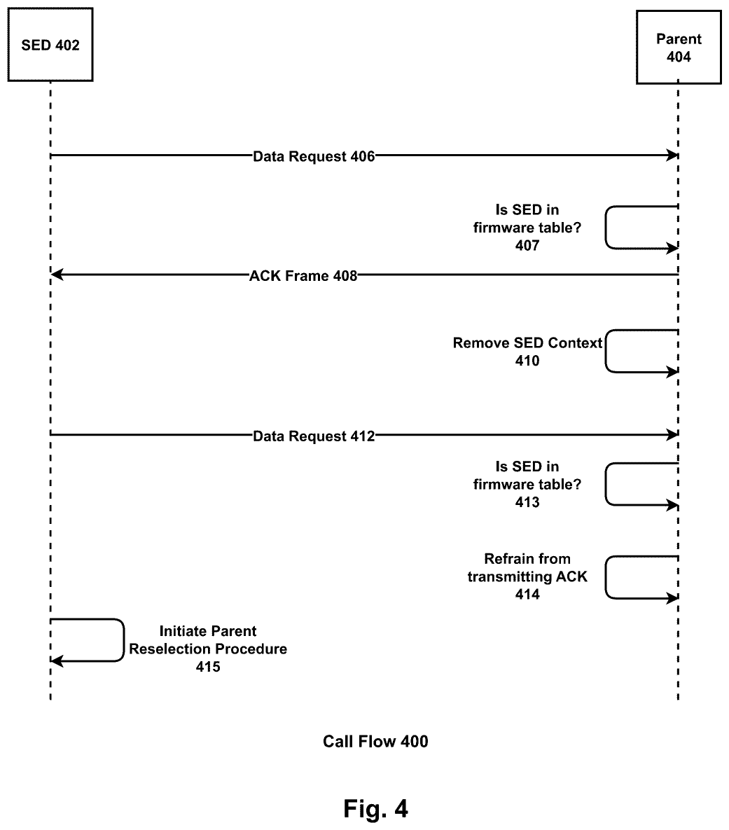

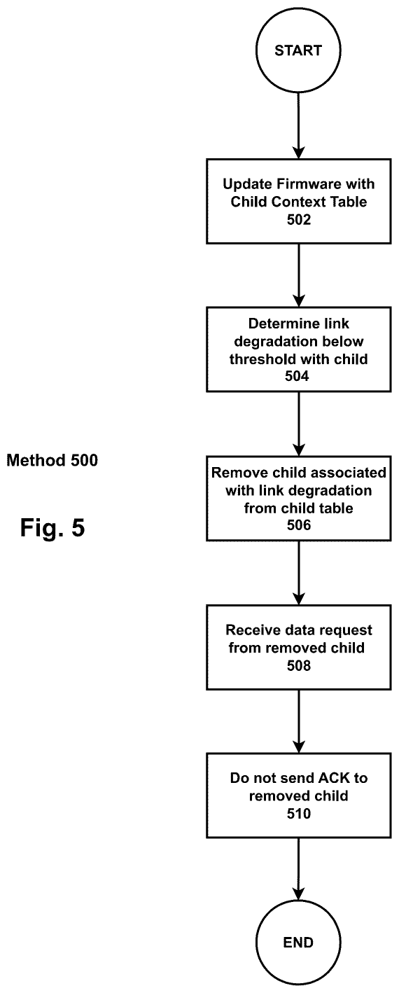

If the context is active, the parent device 301 may generate and transmit an ACK in response to the data request. However, if the context is not active, e.g., there is no entry in the child table 308 for the SED 320, the parent device 301 will not transmit an ACK to the SED 320. If the SED 320 does not receive the ACK, this will cause an ACK handler 316 of the SED 320 to trigger a link loss procedure and initiate a parent reselection procedure 318 to set up a child relationship with another parent device (or the same parent device 301 if the poor link quality was only a temporary issue). Further examples of the operation of the parent device 301 and the SED 320 is described below with reference to the call flow of FIG. 4 and the method of FIG. 5.

The example embodiments may improve power use for both the parent device and the SED by halting further ACKs and data requests after the parent device removes the context for the SED. The example embodiments do not require the parent or the SED to be on the same protocol versions/types or be from the same OEM.

FIG. 4 shows a call flow 400 between a parent device 404 and a SED 402 according to various example embodiments. The call flow 400 further describes operations performed by a parent device 404 and a child 402. The parent device 404 may be similar to the parent device 301 and the SED 402 may be similar to the SED 320 described with reference to FIG. 3. For the purposes of the example call flow 400, the SED 402 and the parent device 404 have already established a parent-child link prior to the call flow 400 beginning, e.g., the parent device 404 has an entry for the SED 402 stored in a child table in firmware (e.g., the child table 308).

In 406, the SED 402 transmits a data request (e.g., an IEEE 802.15.4 data request) to the parent device 404 as part of routine link maintenance procedures.

In 407, the parent device 404 determines if the SED 402 is in the firmware child table. For the purposes of this example, it may be considered that an entry for the SED 402 is in the firmware child table.

In 408, the parent device 404 transmits an ACK frame to the SED 402. The ACK frame is part of typical link maintenance procedures between the parent device 404 and the SED 402.

In 410, the parent device 404 removes the context associated with the SED 402. This may occur for a variety of reasons, such as link degradation. As part of the child context maintenance procedures, the parent device 404 may update the firmware table to remove the entry of the SED 402.

In 412, the SED 402 transmits another data request (e.g., IEEE 802.15.4 data request) to the parent device 404. In 413, the parent device 404 determines whether the SED 402 is in the firmware child table. In this case, the parent device 404 removed the context of the SED 402 in 410, so in the determination 413, the parent 404 does not find the SED 402 in the firmware child table.

In 414, the parent device 404 refrains from transmitting an ACK to the SED 402 based on the determination 413.

In 415, the SED 402 initiates a parent reselection procedure because it has not received an ACK from the parent device 404 within the standardized time period.

FIG. 5 shows a method 500 for operations performed by a parent device (e.g., the parent device 110) in a parent-child relationship with a SED device (e.g., any of SED devices 102-108) according to various example embodiments. The method 500 will be described from the viewpoint of the parent device 110 described with reference to FIGS. 1 and 2 but it should be understood the example method 500 may be implemented by any parent device.

In 502, the parent device 110 updates its firmware with the child context table. The child context table contains context information on a currently linked child SED.

In 504, the parent device 110 determines that the link between itself and the child has fallen below a threshold. In some variants, this threshold is predefined and static. In other variants, this threshold may be dynamically defined based on factors such as link quality, parent and/or child battery status, and SED type and/or capability.

In 506, the parent device 110 removes the child associated with the link degradation from the child context table. Any other SEDs that have not fallen below the threshold remain linked with the parent device 110 and are not removed from the child context table.

In 508, the parent device 110 receives a data request from a removed child. The data request may be an IEEE 802.15.4 data request. In 510, the parent device 110 does not send an ACK to the removed child in response to the data request.

### Examples

In a first example, a method, comprising processing, based on signaling received from a child device, a data request, determining whether an active context exists with the child device based on data stored in firmware and determining whether to respond to the data request based on whether there the active context exists with the child device.

In a second example, the method of the first example, further comprising generating, for transmission to the child device, an acknowledgement (ACK) as a response to the data request when the active context exists with the child device.

In a third example, the method of the first example, further comprising refraining from responding to the data request when the active context does not exist with the child device.

In a fourth example, the method of the first example, wherein the child device comprises a sleepy end device.

In a fifth example, the method of the first example, wherein the data request comprises an IEEE 802.15.4 data request.

In a sixth example, the method of the first example, wherein determining whether to respond to the data request is performed within 192 microseconds from reception of the data request.

In a seventh example, the method of the first example, wherein the data stored in firmware comprises a child table.

In an eighth example, the method of the seventh example, further comprising establishing the active context with the child device and storing an indication of the active context in the child table.

In a ninth example, the method of the eighth example, further comprising determining that a parameter of a communication link with the child device is below a threshold, removing the active context for the child device and removing the indication of the active context from the child table.

In a tenth example, the method of the ninth example, wherein the threshold is a predetermine value.

In an eleventh example, the method of the ninth example, wherein the threshold is based on a link quality, a battery status of the apparatus, a child device battery status, a child device type, or a child device capability.

In a twelfth example, a processor configured to perform any of the firth through eleventh examples.

In a thirteenth example, a processor configured to perform any of the firth through eleventh examples.

In a fourteenth example, a wireless communication device configured to perform any of the firth through eleventh examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
process, based on signaling received from a child device, a data request;
determine whether an active context exists with the child device based on data stored in firmware; and
determine whether to respond to the data request based on whether the active context exists with the child device.

2. The apparatus of claim 1, wherein the processing circuitry is further configured to:
generate, for transmission to the child device, an acknowledgement (ACK) as a response to the data request when the active context exists with the child device.

3. The apparatus of claim 1, wherein the processing circuitry is further configured to refrain from responding to the data request when the active context does not exist with the child device.

4. The apparatus of claim 1, wherein the child device comprises a sleepy end device.

5. The apparatus of claim 1, wherein the data request comprises an IEEE 802.15.4 data request.

6. The apparatus of claim 1, wherein the processing circuitry determines whether to respond to the data request within 192 microseconds from reception of the data request.

7. The apparatus of claim 1, wherein the data stored in firmware comprises a child table.

8. The apparatus of claim 7, wherein the processing circuitry is further configured to:
establish the active context with the child device;
store an indication of the active context in the child table.

9. The apparatus of claim 8, wherein the processing circuitry is further configured to:
determine that a parameter of a communication link with the child device is below a threshold;
remove the active context for the child device; and
remove the indication of the active context from the child table.

10. The apparatus of claim 9, wherein the threshold is a predetermine value.

11. The apparatus of claim 9, wherein the threshold is based on a link quality, a battery status of the apparatus, a child device battery status, a child device type, or a child device capability.

12. A wireless communication device, comprising:
transceiver circuitry configured to communicate with a child device; and
processing circuitry communicatively coupled to the transceiver circuitry and configured to:
process, based on signaling received from the child device, a data request;
determine whether an active context exists between the wireless communication device and the child device based on data stored in firmware; and
determine whether to respond to the data request based on whether the active context exists with the child device.

13. The wireless communication device of claim 12, wherein the processing circuitry is further configured to:
generate, for transmission to the child device, an acknowledgement (ACK) as a response to the data request when the active context exists with the child device.

14. The wireless communication device of claim 12, wherein the processing circuitry is further configured to refrain from responding to the data request when the active context does not exist with the child device.

15. The wireless communication device of claim 12, wherein the child device comprises a sleepy end device.

16. The wireless communication device of claim 12, wherein the data request comprises an IEEE 802.15.4 data request.

17. The wireless communication device of claim 12, wherein the processing circuitry determines whether to respond to the data request within 192 microseconds from reception of the data request.

18. The wireless communication device of claim 12, wherein the data stored in firmware comprises a child table.

19. The wireless communication device of claim 18, wherein the processing circuitry is further configured to:
establish the active context with the child device; and
store an indication of the active context in the child table.

20. A method performed by a parent device, comprising:
processing, based on signaling received from a child device, a data request;
determining whether the parent device has an active context with the child device based on data stored in firmware of the parent device; and
determining whether to respond to the data request based on whether the parent device has the active context with the child device.
